(19) United States
(12) Patent Application Publication
(10) Pub. No.: US 2024/0280436 A1
(43) Pub. Date: Aug. 22, 2024

(54) VISUALIZATION DEVICE, VISUALIZATION METHOD, VISUALIZATION PROGRAM

(71) Applicant: Nippon Telegraph and Telephone Corporation, Tokyo (JP)

(72) Inventors: Yasuhiro MOCHIDA, Musashino-shi, Tokyo (JP); Takuro YAMAGUCHI, Musashino-shi, Tokyo (JP); Daisuke Shirai, Musashino-shi, Tokyo (JP); Takahiro YAMAGUCHI, Musashino-shi, Tokyo (JP)

(21) Appl. No.: 18/567,477

(22) PCT Filed: Jun. 10, 2021
(86) PCT No.: PCT/JP2021/022139

§ 371 Date: Dec. 6, 2023

(51) Int. Cl. G01M 11/02; G01L 1/24; G01M 11/08

(52) U.S. Cl. CPC G01M 11/0257; G01L 1/242; G01M 11/0207; G01M 11/088

(57) ABSTRACT

Included are: a signal change detection unit (1) that detects a change occurring in an optical signal when a physical stimulus is applied to an optical fiber (FB); and a display control unit (3) that displays identification information indicating the optical fiber (FB) in which the change has occurred in the optical signal.

### TECHNICAL FIELD

The present invention relates to a visualization device, a visualization method, and a visualization program.

### BACKGROUND ART

A large number of optical fibers are used in a communication network. During maintenance of the communication network or the like, it is necessary to identify the individual optical fibers. Since the optical fibers are similar in appearance, it is difficult to visually identify the individual optical fibers.

Non Patent Literature 1 discloses attaching markers on which preset patterns are printed to respective real objects, capturing images of the respective markers with a camera, recognizing the markers on the basis of the captured camera images, and consequently identifying the individual real objects.

### CITATION LIST

### Non Patent Literature

Non Patent Literature 1: Kato, H., Billinghurst, M. “Marker tracking and hmd calibration for a video-based augmented reality conferencing system.”, In Proceedings of the 2nd IEEE and ACM International Workshop on Augmented Reality (IWAR 99), October 1999.

### SUMMARY OF INVENTION

### Technical Problem

However, to recognize a specific optical fiber from among a plurality of optical fibers by adopting the technology disclosed in Non Patent Literature 1, it is necessary to add markers having unique patterns for identification to a large number of optical fibers, and it takes much time and effort to add the markers. In addition, to identify the individual optical fibers, it is necessary to search for the markers added to the respective optical fibers. In a case where the optical fiber lengths are long, it may take time to search for the markers.

The present invention has been made in view of the above circumstances, and an object thereof is to provide a visualization device, a visualization method, and a visualization program capable of identifying individual optical fibers from a large number of optical fibers with a simple operation.

### Solution to Problem

A visualization device of an aspect of the present invention is a visualization device that visualizes a specific optical fiber from a plurality of optical fibers, the visualization device including: a signal change detection unit that detects a change occurring in an optical signal when a physical stimulus is applied to each optical fiber; and a display control unit that displays identification information indicating an optical fiber in which a change has occurred in the optical signal.

A visualization method of an aspect of the present invention is a visualization method for visualizing a specific optical fiber from a plurality of optical fibers, the visualization method including: a step of detecting a change occurring in an optical signal when a physical stimulus is applied to each optical fiber; and a step of displaying identification information indicating an optical fiber in which a change has occurred in the optical signal.

An aspect of the present invention is a visualization program for causing a computer to function as the visualization device.

### Advantageous Effects of Invention

According to the present invention, it is possible to identify individual optical fibers from a large number of optical fibers with a simple operation.

### BRIEF DESCRIPTION OF DRAWINGS

FIG. 1 is a block diagram illustrating a configuration of a visualization device according to a first embodiment, and peripheral devices thereof.

FIG. 2 is a block diagram illustrating a configuration of a network system, illustrating connection between transmission devices each mounting the visualization device thereon according to the first embodiment.

FIG. 3 is an explanatory diagram illustrating an example of a connection relationship table stored in a connection database.

FIG. 4 is a flowchart illustrating a processing procedure by the visualization device according to the first embodiment.

FIG. 5 is a display example of an image of identification information on a specified optical fiber.

FIG. 6 is a block diagram illustrating a configuration of a visualization device according to a second embodiment, and peripheral devices thereof.

FIG. 7 is a flowchart illustrating a processing procedure by the visualization device according to the second embodiment.

FIG. 8 is a display example of an image illustrating a state in which a pinch operation is applied to an optical fiber and IDs of transmission devices to which the optical fiber to which the pinch operation is applied is connected.

FIG. 9 is a block diagram illustrating a configuration of a visualization device according to a third embodiment, and peripheral devices thereof.

FIG. 10 is an explanatory diagram 10 illustrating a configuration of a network system, illustrating connection between transmission devices each mounting the visualization device according to the third embodiment thereon.

FIG. 11 is an explanatory diagram 11 illustrating an example of a video flow table stored in a video flow database.

FIG. 12 is a flowchart illustrating a processing procedure by the visualization device according to the third embodiment.

FIG. 13 is a display example of an image 13 illustrating a state in which a pinch operation is applied to an optical fiber and information on a video flow.

FIG. 14 is a block diagram illustrating a hardware configuration of the present embodiments.

### DESCRIPTION OF EMBODIMENTS

### Description of First Embodiment

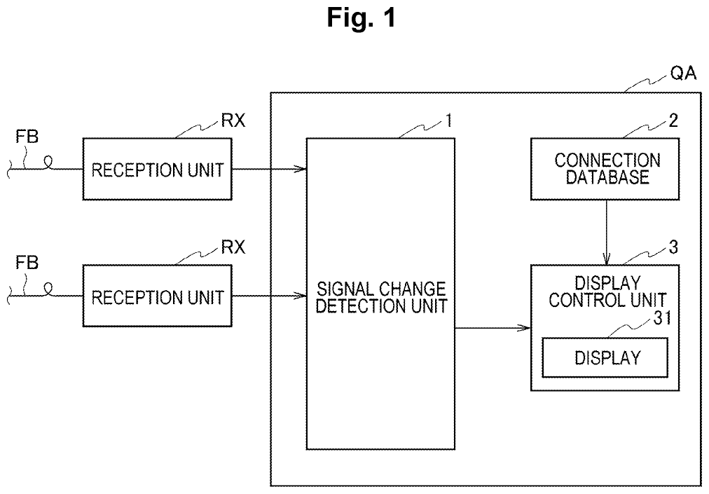

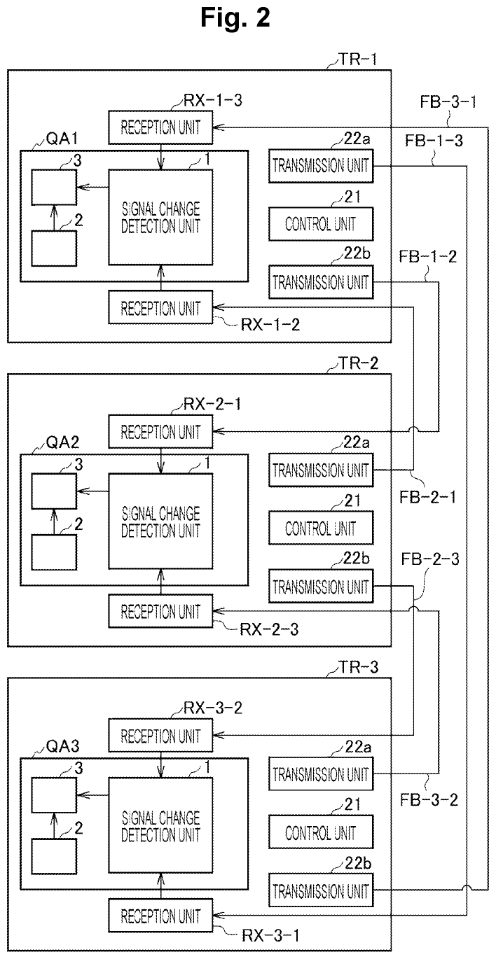

Hereinafter, a first embodiment of the present invention will be described. FIG. 1 is a block diagram illustrating a configuration of a visualization device QA according to the first embodiment, and peripheral devices thereof. FIG. 2 is a schematic configuration diagram of a network system illustrating connection between transmission devices TR each mounting the visualization device QA thereon. The present embodiment displays and visualize information on a specific optical fiber selected by a user from a plurality of optical fibers that transmit optical signals.

In the present embodiment, as an example, description will be given of a network system in which three transmission devices TR-1, TR-2, and TR-3 are connected to each other by optical fibers FB, as illustrated in FIGS. 1 and 2.

As illustrated in FIG. 2, each of the transmission devices TR-1, TR-2, and TR-3 includes a control unit 21, two transmission units 22a and 22b, two reception units RX, and the visualization device QA (QA1, QA2, QA3), and performs data communication by using optical fibers. The control unit 21 controls data communication by the transmission devices TR-1, TR-2, and TR-3. Description of detailed control will be omitted. The transmission units 22a and 22b transmit optical signals to other transmission devices. The reception units RX receive optical signals transmitted from other transmission devices.

As illustrated in FIG. 1, the visualization device QA includes a signal change detection unit 1, a connection database 2, and a display control unit 3. The signal change detection unit 1 is connected to two reception units RX.

As illustrated in FIG. 2, the visualization device QA1 mounted on the transmission device TR-1 is connected to two reception units RX-1-2 and RX-1-3. The visualization device QA2 mounted on the transmission device TR-2 is connected to two reception units RX-2-1 and RX-2-3. The visualization device QA3 mounted on the transmission device TR-3 is connected to two reception units RX-3-1 and RX-3-2.

The transmission devices TR-1 and TR-2 are connected to each other by two optical fibers FB-1-2 and FB-2-1. That is, an optical signal transmitted from the transmission unit 22b of the transmission device TR-1 is received by the reception unit RX-2-1 via the optical fiber FB-1-2, and an optical signal transmitted from the transmission unit 22a of the transmission device TR-2 is received by the reception unit RX-1-2 via the optical fiber FB-2-1.

The transmission devices TR-2 and TR-3 are connected to each other by two optical fibers FB-2-3 and FB-3-2. That is, an optical signal transmitted from the transmission unit 22b of the transmission device TR-2 is received by the reception unit RX-3-2 via the optical fiber FB-2-3, and an optical signal transmitted from the transmission unit 22a of the transmission device TR-3 is received by the reception unit RX-2-3 via the optical fiber FB-3-2.

The transmission devices TR-3 and TR-1 are connected to each other by two optical fibers FB-3-1 and FB-1-3. That is, an optical signal transmitted from the transmission unit 22b of the transmission device TR-3 is received by the reception unit RX-1-3 via the optical fiber FB-3-1, and an optical signal transmitted from the transmission unit 22a of the transmission device TR-1 is received by the reception unit RX-3-1 via the optical fiber FB-1-3.

Hereinafter, in a case where each visualization device, each transmission device, each reception unit, and each optical fiber are specified and indicated, they are indicated with suffixes as “visualization device QA1”, “transmission device TR-1”, “reception unit RX-1-2”, and “optical fiber FB-2-1”. In a case where each visualization device, each transmission device, each reception unit, and each optical fiber are not specified or in a case where the visualization devices, the transmission devices, the reception devices, and the optical fibers each are collectively referred to, they are indicated without suffixes as “visualization device QA”, “transmission device TR”, “reception unit RX”, and “optical fiber FB”.

As illustrated in FIG. 1, the reception unit RX is connected to the optical fiber FB and receives an optical signal transmitted via the optical fiber FB. For example, the reception unit RX-1-2 illustrated in FIG. 2 receives the optical signal transmitted from the transmission unit 22a of the transmission device TR-2.

The reception unit RX outputs a feature value of the received optical signal to the signal change detection unit 1. Note that the number of reception units RX mounted on one transmission device TR is not limited to two.

The feature value of the optical signal is, for example, a light reception level of the optical signal, a variance of a constellation of multi-level modulation, a bit error rate before error correction, and the like. Information on these feature values can be acquired through digital diagnostic monitoring (DMM) or transponder abstraction interface (TAI).

The signal change detection unit 1 analyzes the feature value output from the reception unit RX and detects a change in the feature value. For example, in a case where a pinch operation such as a bending stress is applied to the optical fiber FB, a change occurs in each feature value, such as a decrease in a light reception level, an increase in a variance of a constellation, and an increase in a bit error rate before error correction, in the optical signal transmitted by the optical fiber FB. Note that the “pinch operation” refers to, for example, an operation of pinching and bending the optical fiber FB with fingers of a person. The pinch operation is an example of a physical stimulus.

The signal change detection unit 1 detects that a pinch operation such as a bending stress is applied to a target optical fiber FB in a case where a change occurs in the feature value output from the reception unit RX.

Here, if a bit error rate after error correction is error free, even if a pinch operation such as an appropriate bending stress is applied to the optical fiber FB, an influence on communication by the optical fiber FB does not occur. That is, by applying an appropriate pinch operation to the optical fiber FB, it is possible to intentionally change the above-described feature value without affecting communication by the optical fiber FB.

In a case where a change in the feature value is detected in the optical signal received by the reception unit RX, the signal change detection unit 1 outputs an ID of the reception unit RX to the display control unit 3.

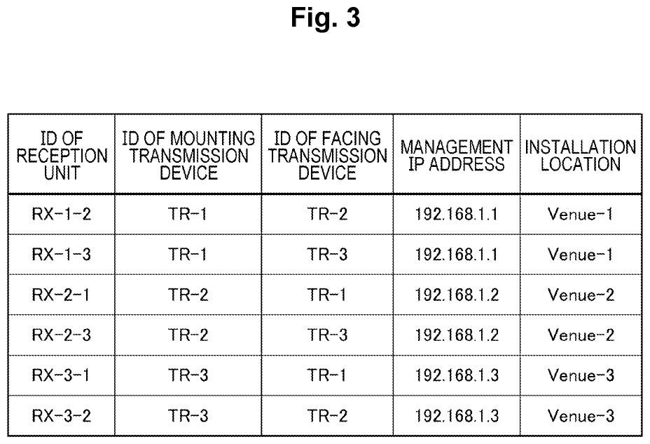

The connection database 2 stores a connection relationship table indicating information regarding various connections in the reception unit RX. FIG. 3 is an explanatory diagram illustrating an example of the connection relationship table stored in the connection database 2. As illustrated in FIG. 3, the connection relationship table describes information indicating correspondence among an ID of each reception unit RX, an ID of a transmission device TR (mounting transmission device) on which the reception unit RX is mounted, an ID of a transmission device TR (facing transmission device) that performs communication with the reception unit RX, a management IP address of the transmission device TR, and an installation location.

For example, as illustrated in FIG. 3, the reception unit RX-1-2 (reception unit whose ID is “RX-1-2”) is mounted on the transmission device TR-1 (transmission device whose ID is “TR-1”) and faces the transmission device TR-2 (transmission device whose ID is “TR-2”). In addition, the management IP address of the reception unit RX-1-2 is “192.168.1.1”, and the installation location is “Venue-1”.

Returning to FIG. 1, the display control unit 3 includes a display 31 for image display. The display control unit 3 acquires the ID of the reception unit RX output from the signal change detection unit 1. For example, in a case of the reception unit RX-1-3, various types of information corresponding to the reception unit RX-1-3 are acquired from the connection relationship table stored in the connection database 2. The display control unit 3 specifies the optical fiber FB to which a physical stimulus is applied on the basis of the acquired various types of information, and displays an image (identification information) indicating the specified optical fiber FB on the display 31. That is, the display control unit 3 displays identification information indicating the optical fiber FB in which a change has occurred in the optical signal. As the display 31, a liquid crystal display, a transmissive head-mounted display, or the like can be used.

### Operation of First Embodiment

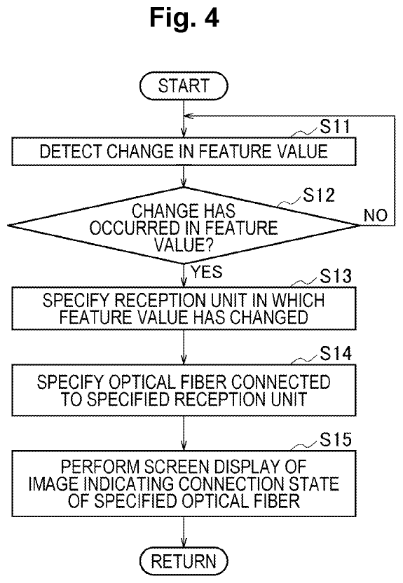

Next, operation of the visualization device QA according to the first embodiment will be described with reference to a flowchart illustrated in FIG. 4.

In a case where the user wants to check which transmission device TR a desired optical fiber FB among the plurality of optical fibers FB is connected to, the user applies a pinch operation such as a bending stress to the desired optical fiber FB. As a result, a change occurs in the feature value of the optical signal received by a reception unit RX connected to the desired optical fiber FB. In step S11, the signal change detection unit 1 detects a change in the feature value included in the optical signal received by the reception unit RX.

In step S12, the signal change detection unit 1 determines whether or not a change has occurred in the feature value of the optical signal detected by each reception unit RX. In a case where the change in the feature value has occurred (S12; YES), the processing proceeds to step S13, and if not (S12; NO), the processing returns to step S11.

In step S13, the signal change detection unit 1 specifies a reception unit RX in which the change in the feature value has occurred, and outputs an ID of the specified reception unit RX to the display control unit 3.

In step S14, the display control unit 3 refers to the connection relationship table stored in the connection database 2, acquires an ID of a mounting transmission device on which the specified reception unit RX is mounted and an ID of a facing transmission device, and specifies an optical fiber FB connecting both to each other. For example, as illustrated in FIG. 3, in a case where the ID of the reception unit RX is “RX-1-2”, the ID of the mounting transmission device is “TR-1” and the ID of the facing transmission device is “TR-2”, and it is specified that the optical fiber FB connecting these devices to each other is the FB-2-1.

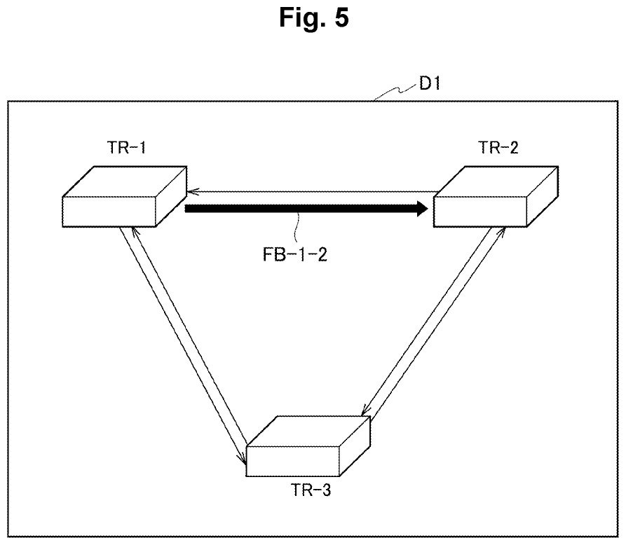

In step S15, the display control unit 3 displays a visualization image including information on the specified optical fiber FB on the display 31. FIG. 5 is an explanatory diagram illustrating an example of a visualization image D1 displayed on the display 31. As illustrated in FIG. 5, the visualization image D1 displays the transmission devices TR-1, TR-2, and TR-3 and arrows indicating the optical fibers FB connecting the transmission devices to each other. In addition, the specified optical fiber FB-1-2 is highlighted. Specifically, the optical fiber FB-1-2 is displayed by a thicker line than other optical fibers FB. That is, the optical fiber FB-1-2 to which the user has applied a pinch operation is displayed with a thick line, and thus, is visualized. As a result, the user can easily recognize which transmission device TR the desired optical fiber FB is connected to.

### Effects of First Embodiment

As described above, the visualization device QA according to the first embodiment is a visualization device that visualizes a specific optical fiber from the plurality of optical fibers FB, and includes the signal change detection unit 1 that detects a change occurring in an optical signal when a physical stimulus is applied to each optical fiber FB, and the display control unit 3 that displays identification information indicating an optical fiber FB in which a change has occurred in the optical signal.

In the first embodiment, the optical fiber FB to which a pinch operation such as a bending stress is applied by the user is highlighted by a thick line or the like on the visualization image D1 displayed on the display 31.

For this reason, the user can visually recognize to which transmission device TR the optical fiber FB is connected, with a simple operation of applying a pinch operation such as a bending stress to the optical fiber FB. As a result, it is possible to identify individual optical fibers from a large number of optical fibers with a simple operation.

That is, the visualization device QA according to the present embodiment enables identification of the optical fiber FB without addition of a marker to the optical fiber FB. In a case where a marker is added to the optical fiber FB, it is necessary to find a position of the added marker, but in the present embodiment, the optical fiber FB can be identified from any position of the optical fiber FB.

### Configuration of Second Embodiment

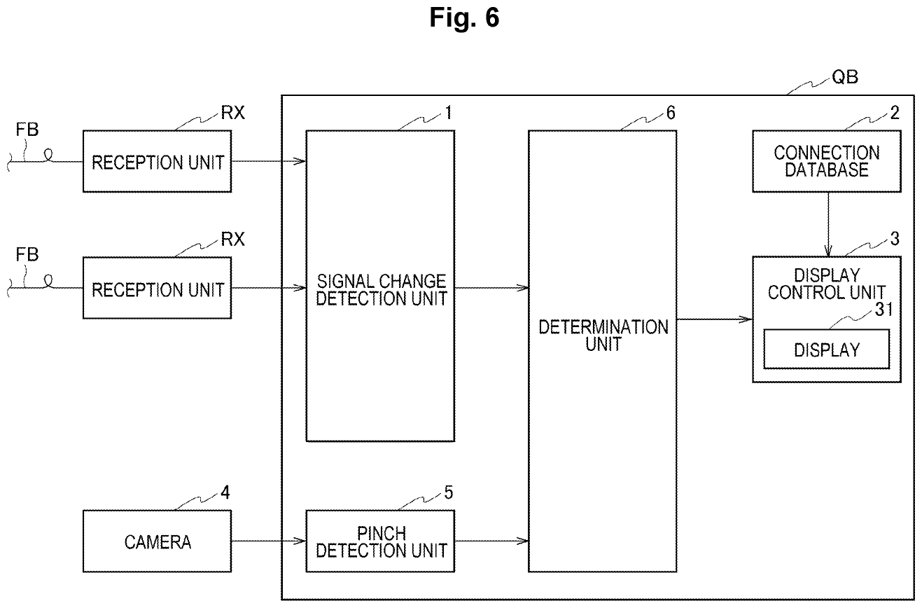

Next, a second embodiment will be described. FIG. 6 is a block diagram illustrating a configuration of a visualization device QB according to the second embodiment, and peripheral devices thereof. The visualization device QB illustrated in FIG. 6 is different from the visualization device QA illustrated in FIG. 1 described above in that the visualization device QB includes a pinch detection unit 5 (stimulus detection unit) and a determination unit 6. The pinch detection unit 5 is connected to a camera (image capturing unit). The other constituent elements are the same as those in FIG. 1 described above, and thus, the same reference numerals are given to the constituent elements and description thereof will be omitted.

A camera 4 is provided, for example, in the vicinity of the optical fiber FB. The camera 4 captures an image of a state in which a physical stimulus is applied to each optical fiber FB. The camera 4 outputs the captured image to the pinch detection unit 5.

The pinch detection unit 5 detects that a physical stimulus such as a pinch operation is applied to the optical fiber FB from the image captured by the camera 4. The camera 4 can be mounted on, for example, a transmissive head-mounted display.

The determination unit 6 acquires information output from the signal change detection unit 1 and information output from the pinch detection unit 5. The information output from the signal change detection unit 1 includes an ID of a reception unit RX in which a change has occurred in the optical signal. The information output from the pinch detection unit 5 includes information indicating that a pinch operation is applied to one of the plurality of optical fibers FB.

In a case where the ID of the reception unit RX in which the change has occurred in the optical signal is input and the pinch operation is applied to the optical fiber FB, the determination unit 6 performs control to output the ID of the reception unit RX to the display control unit 3.

### Operation of Second Embodiment

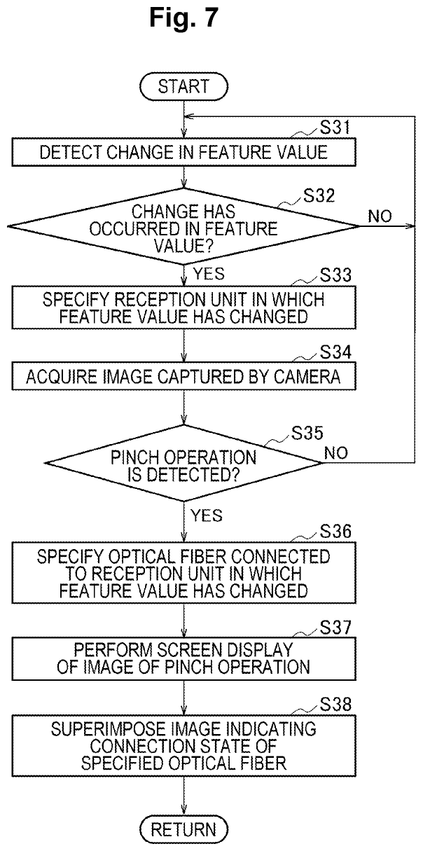

Next, operation of the visualization device QB according to the second embodiment will be described with reference to a flowchart illustrated in FIG. 7.

In step S31, the signal change detection unit 1 detects a change in the feature value included in the optical signal received by a reception unit RX.

In step S32, the signal change detection unit 1 determines whether or not a change has occurred in the feature value of the optical signal detected by each reception unit RX. In a case where the change in the feature value has occurred (S32; YES), the processing proceeds to step S33, and if not (S32; NO), the processing returns to step S31.

In step S33, the signal change detection unit 1 specifies a reception unit RX in which the change in the feature value has occurred, and outputs the ID of the specified reception unit RX to the determination unit 6.

In step 534, the pinch detection unit 5 acquires an image of the optical fiber FB captured by the camera 4.

In step S35, the pinch detection unit 5 refers to the image of the optical fiber FB and determines whether or not a pinch operation is detected. In a case where the pinch operation is detected (S35; YES), the processing proceeds to step S36, and if not (S35; NO), the processing returns to step S31.

In step S36, the determination unit 6 determines that a pinch operation is applied to an optical fiber FB connected to a reception unit RX in which a change has occurred in the feature value of the optical signal. The determination unit 6 outputs an ID of the reception unit RX to the display control unit 3.

The display control unit 3 refers to the connection relationship table stored in the connection database 2, acquires an ID of a mounting transmission device on which the specified reception unit RX is mounted and an ID of a facing transmission device, and specifies an optical fiber FB connecting both to each other. For example, as illustrated in FIG. 3, in a case where the ID of the reception unit RX is “RX-1-2”, the ID of the mounting transmission device is “TR-1” and the ID of the facing transmission device is “TR-2”, and it is specified that the optical fiber FB connecting these devices to each other is the FB-2-1.

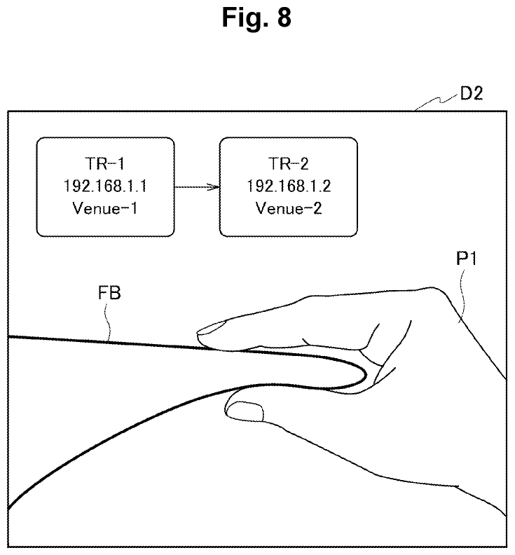

In step S37, the display control unit 3 displays an image indicating a state in which a pinch operation is applied to the optical fiber FB on the display 31. Specifically, as illustrated in FIG. 8, a visualization image D2 indicating a connection state of the optical fiber FB is superimposed and displayed on a transmissive head-mounted display while fingers of a person P1 and the optical fiber FB are realistically put in a field of view through the transmissive head-mounted display such as a HoloLens. That is, the display control unit 3 superimposes and displays identification information on either one of a real image in which a physical stimulus is applied to an optical fiber or an image, captured by the camera 4 (image capturing unit), of a state in which the physical stimulus is applied to the optical fiber.

In step S38, the display control unit 3 superimposes and displays an image indicating the specified connection state of the optical fiber FB on the visualization image D2. That is, identification information indicating the optical fiber FB in which a change has occurred in the optical signal is displayed. Specifically, as illustrated in FIG. 8, an image is superimposed and displayed on the visualization image D2, the image indicating that the optical fiber FB is connected from a reception unit RX of the transmission device TR-1, the management IP address “192.168.1.1”, and the installation location “Venue-1” toward a reception unit RX of the transmission device TR-2, the management IP address “192.168.1.2”, and the installation location “Venue-2”. That is, the optical fiber FB on which the user has performed the pinch operation is visualized. As a result, the user can easily recognize the optical fiber FB on which the user has performed the pinch operation.

### Effects of Second Embodiment

As described above, in the visualization device QB according to the second embodiment, on condition that the pinch operation by the user has been performed on the optical fiber FB, the reception unit RX is specified in which a change has occurred in the feature value of the optical signal, and further the optical fiber FB is specified connected to the reception unit RX.

Thus, the robustness at the time of detecting the optical fiber FB can be improved. That is, in a case where the optical fiber FB is specified by detecting only a change in the feature value of the optical signal, there is a possibility that erroneous detection occurs in a case where a change occurs in the optical signal due to another factor. In the present embodiment, there is a condition that the pinch operation is detected, occurrence of such erroneous detection can be avoided.

### Configuration of Third Embodiment

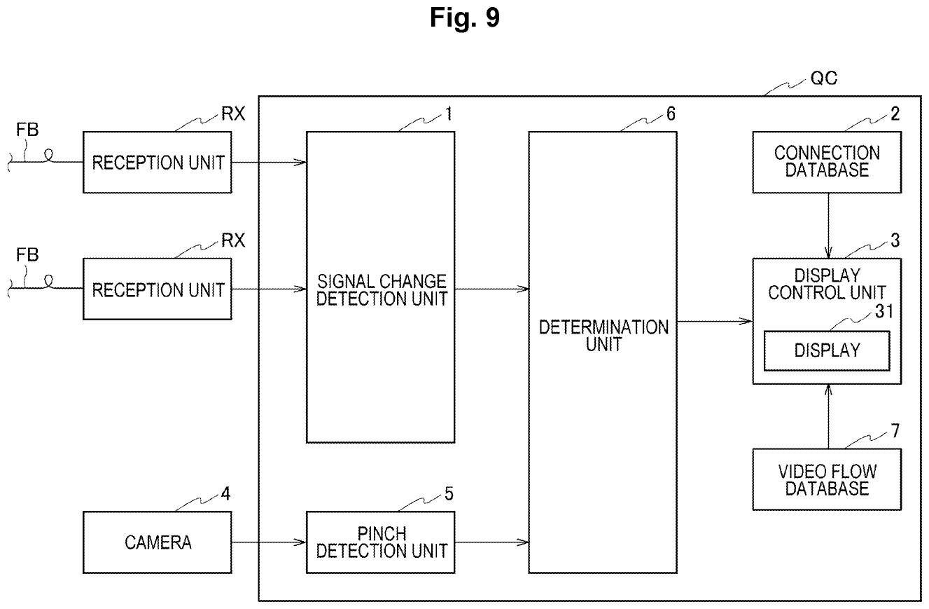

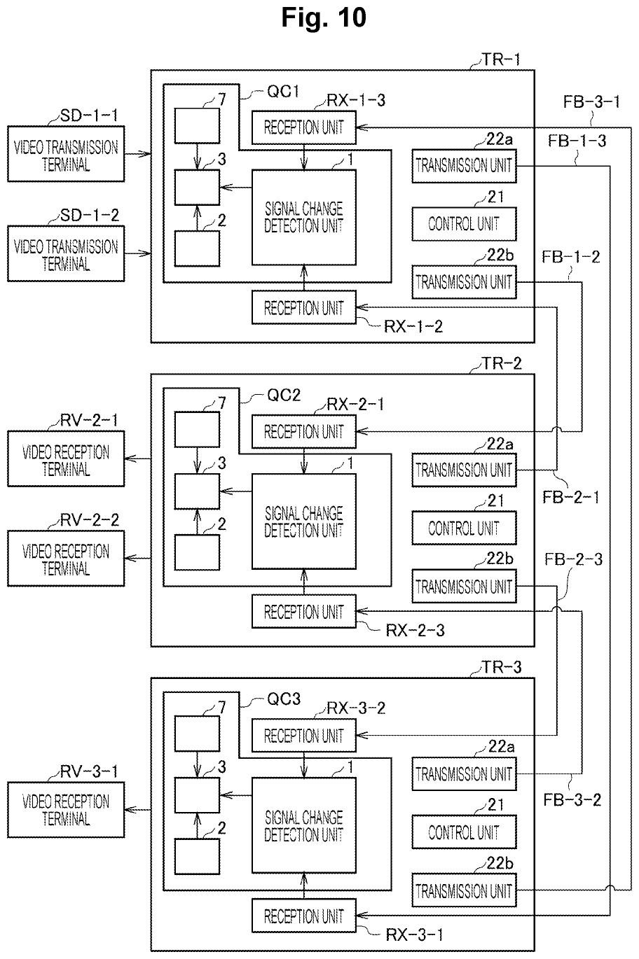

Next, a third embodiment will be described. FIG. 9 is a block diagram illustrating a configuration of a visualization device QC according to the third embodiment, and peripheral devices thereof. FIG. 10 is a schematic configuration diagram of a network system illustrating connection between the transmission devices TR each mounting the visualization device QC thereon.

As illustrated in FIG. 10, video transmission terminals SD-1-1 and SD-1-2 are connected to the transmission device TR-1. A video transmission terminal SD is a terminal that transmits a video flow from the transmission device TR-1 to another transmission device TR.

Video reception terminals RV-2-1 and RV-2-2 are connected to the transmission device TR-2. In addition, a video reception terminal RV-3-1 is connected to the transmission device TR-3. A video reception terminal RV is a terminal that receives a video flow transmitted from a video transmission terminal SD.

The visualization device QC illustrated in FIG. 9 is different from the visualization device QB illustrated in FIG. 5 described above in that the visualization device QC includes a video flow database 7. The other constituent elements are the same as those in FIG. 5, and thus, the same reference numerals are given to the constituent elements and description thereof will be omitted.

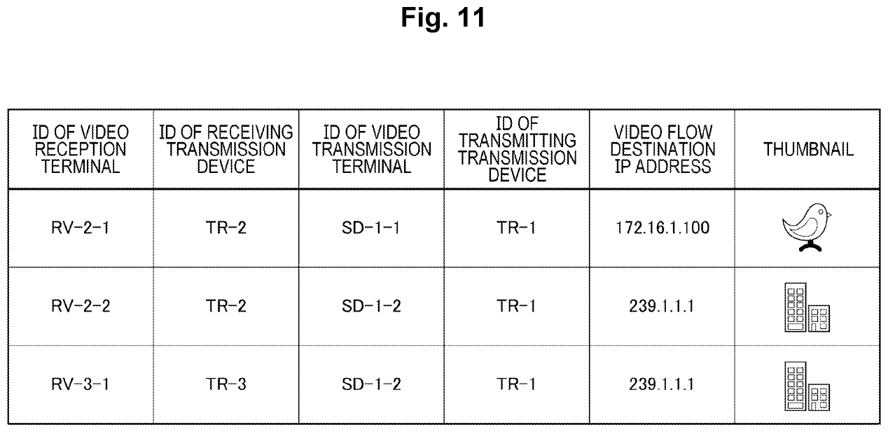

For example, as illustrated in FIG. 11, the video flow database 7 stores a video flow table indicating a relationship among an ID of a video reception terminal RV, an ID of a receiving transmission device TR to which the video reception terminal RV is connected, an ID of a video transmission terminal SD, an ID of a transmitting transmission device TR to which the video transmission terminal SD is connected, a video flow destination IP address, and a thumbnail.

As the video flow, “SMPTE ST 2110” can be used. It is possible to create the video flow database 7 by acquiring information from the video transmission terminal SD and the video reception terminal RV by using “Networked Media Open Specification (NMOS)”.

### Operation of Third Embodiment

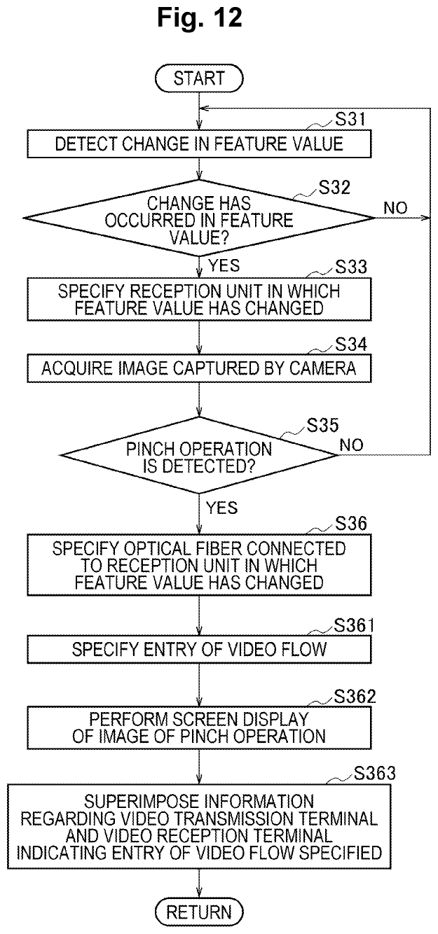

Next, operation of the visualization device QC according to the third embodiment will be described with reference to a flowchart illustrated in FIG. 12. Note that the processing in steps S31 to S36 illustrated in FIG. 12 is the same as the processing in steps S31 to S36 illustrated in FIG. 7, and thus description thereof will be omitted. Hereinafter, the processing of steps S361 to S363 illustrated in FIG. 12 will be described.

When an optical fiber FB connected to a reception unit RX in which the feature value has changed is specified in the processing of step S36, the display control unit 3 refers to the video flow table stored in the video flow database 7 and specifies an entry of a video flow in step S361.

Specifically, the display control unit 3 refers to the connection relationship table (see FIG. 3) stored in the connection database 2 and acquires a combination of the ID of the receiving transmission device TR and the ID of the transmitting transmission device TR. The display control unit 3 refers to the video flow table illustrated in FIG. 11 and searches for an entry in which the ID of the receiving transmission device TR matches the ID of the transmission device TR to which the video reception terminal RV is connected and the ID of the transmitting transmission device TR matches the ID of the transmission device TR to which the video transmission terminal SD is connected. In a case where the entry is found, information indicating the connection relationship is set as display information. In a case where there is a plurality of the entries, a plurality of pieces of display information indicating the connection relationship is set.

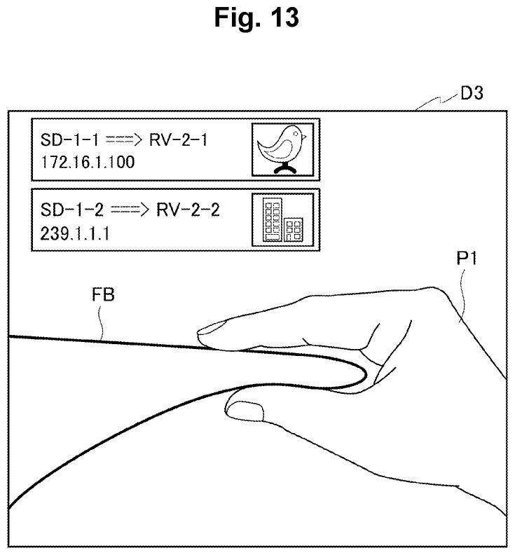

In step S362, the display control unit 3 displays an image indicating a state in which a pinch operation is applied to the optical fiber FB on the display 31. Specifically, as illustrated in FIG. 13, a visualization image D3 indicating identification information on a video flow flowing from the video transmission terminal SD to the video reception terminal RV is superimposed and displayed on a transmissive head-mounted display while fingers of the person P1 and the optical fiber FB are realistically put in a field of view through the transmissive head-mounted display such as a HoloLens.

In step S363, the display control unit 3 superimposes and displays information regarding the video transmission terminal SD and the video reception terminal RV indicating the entry of the video flow specified, on the visualization image D3 illustrated in FIG. 13.

Specifically, as illustrated in FIG. 13, an image indicating connection from the video transmission terminal SD-1-1 to the video reception terminal RV-2-1, a video flow destination IP address “172.16.1.100”, and a thumbnail are superimposed and displayed on the visualization image D3.

Further, an image indicating connection from the video transmission terminal SD-1-2 to the video reception terminal RV-2-2, a video flow destination IP address “239.1.1.1”, and a thumbnail are superimposed and displayed on the visualization image D3. That is, when a transmission device TR connected to an optical fiber FB in which a change in the optical signal has occurred is specified, the display control unit 3 refers to the video flow database 7 and specifies a video reception terminal RV connected to the transmission device TR specified, and a video transmission terminal SD, and displays an image indicating identification information regarding a video flow flowing from the video transmission terminal SD to the video reception terminal RV that are specified. As a result, the video flow of the optical fiber FB on which the user has performed the pinch operation is visualized, and the user can easily recognize the video flow of the optical fiber FB on which the user has performed the pinch operation.

### Effects of Third Embodiment

As described above, in the visualization device QC according to the third embodiment, on condition that the pinch operation by the user has been performed on the optical fiber FB, the reception unit RX is specified in which a change has occurred in the feature value of the optical signal, and further the optical fiber FB is specified connected to the reception unit RX.

Thus, similarly to the second embodiment described above, the robustness at the time of detecting the optical fiber FB can be improved. That is, it is possible to avoid a problem that erroneous detection occurs in a case where a change occurs in the optical signal due to another factor.

In the visualization device QC according to the third embodiment, the information regarding the video flow transmitted via the optical fiber FB is superimposed and displayed on the visualization image D3, whereby efficiency of operation of a network for video transmission can be enhanced.

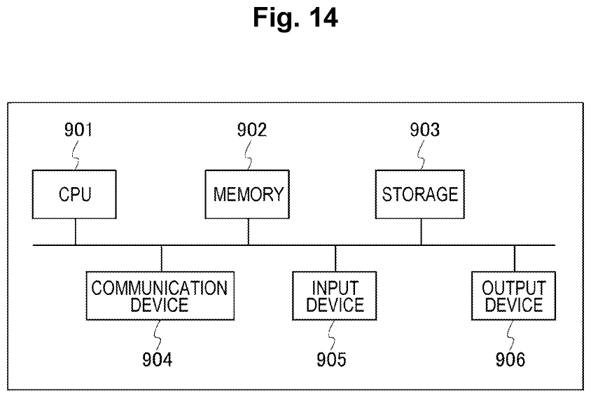

As the visualization devices QA, QB, and QC of the present embodiments described above, a general-purpose computer system can be used including a central processing unit (CPU, processor) 901, a memory 902, a storage 903 (hard disk drive: HDD, solid state drive: SSD), a communication device 904, an input device 905, and an output device 906, as illustrated in FIG. 14, for example. The memory 902 and the storage 903 are storage devices. In the computer system, the CPU 901 executes a predetermined program loaded on the memory 902, whereby each function of the visualization devices QA, QB, and QC is implemented.

Note that the visualization devices QA, QB, and QC may be implemented by one computer or may be implemented by a plurality of computers. In addition, the visualization devices QA, QB, and QC may be virtual machines implemented on a computer.

Note that programs for the visualization devices QA, QB, and QC can be stored in a computer-readable recording medium such as an HDD, SSD, universal serial bus (USB) memory, compact disc (CD), or digital versatile disc (DVD), or can be distributed via a network.

Note that the present invention is not limited to the above embodiments, and various modifications can be made within the scope of the spirit of the present invention.

### REFERENCE SIGNS LIST

1 signal change detection unit
2 connection database
3 display control unit
4 camera (image capturing unit)
5 pinch detection unit
6 determination unit
7 video flow database
21 control unit
22a, 22b transmission unit
31 display
QA, QB, QC visualization device
D1, D2, D3 visualization image
FB optical fiber
RV video reception terminal
RX reception unit
SD video transmission terminal
TR transmission device

1. A visualization device for visualizing a specific optical fiber from a plurality of optical fibers,
the visualization device comprising:
a signal change detection unit, including one or more processors, configured to detect a change occurring in an optical signal when a physical stimulus is applied to each optical fiber; and
a display control unit, including one or more processors, configured to display identification information indicating an optical fiber in which a change has occurred in the optical signal.

2. The visualization device according to claim 1, further comprising
a stimulus detection unit, including one or more processors, configured to detect that a stimulus is applied to the optical fiber on a basis of an image captured by an image capturing unit that captures an image of the optical fiber, wherein
the display control unit is configured to display the identification information in a case where it is detected by the stimulus detection unit that a stimulus is applied to the optical fiber.

3. The visualization device according to claim 2, wherein
the display control unit is configured to superimpose and displays the identification information on either one of a real image in which a physical stimulus is applied to the optical fiber or an image, captured by the image capturing unit, of a state in which the physical stimulus is applied to the optical fiber.

4. The visualization device according to claim 2, further comprising
a video flow database indicating a connection relationship among a video transmission terminal that transmits a video flow, a transmission device connected to the video transmission terminal, a video reception terminal that receives the video flow, and a transmission device connected to the video reception terminal, wherein
the display control unit is configured to,
when a transmission device connected to an optical fiber in which a change in the optical signal has occurred is specified, refer to the video flow database and specifies a video reception terminal connected to the transmission device specified, and a video transmission terminal, and
display an image indicating identification information regarding a video flow flowing from the video transmission terminal to the video reception terminal that are specified.

5. The visualization device according to any one of claim 2, wherein
the stimulus detection unit is configured to detect that the stimulus is applied in a case where a user applies a bending stress to the optical fiber on the basis of the image captured by the image capturing unit.

6. The visualization device according to any one of claim 1, wherein the change occurring in the optical signal is a change in at least one of a light reception level, a variance of a constellation, or a bit error rate.

7. A visualization method for visualizing a specific optical fiber from a plurality of optical fibers,
the visualization method comprising:
a step of detecting a change occurring in an optical signal when a physical stimulus is applied to each optical fiber; and
a step of displaying identification information indicating an optical fiber in which a change has occurred in the optical signal.

8. A non-transitory computer-readable storage medium storing a visualization program causing a computer to perform operations of a visualization method for visualizing a specific optical fiber from a plurality of optical fibers, the operations comprising:
detecting a change occurring in an optical signal when a physical stimulus is applied to each optical fiber; and
displaying identification information indicating an optical fiber in which a change has occurred in the optical signal.

9. The visualization method according to claim 7, further comprising:
detecting that a stimulus is applied to the optical fiber on a basis of an image captured by an image capturing unit that captures an image of the optical fiber; and
displaying the identification information in a case where it is detected that a stimulus is applied to the optical fiber.

10. The visualization method according to claim 9, further comprising:
superimposing and displays the identification information on either one of a real image in which a physical stimulus is applied to the optical fiber or an image, captured by the image capturing unit, of a state in which the physical stimulus is applied to the optical fiber.

11. The visualization method according to claim 9, further comprising:
storing, in a video flow database, data indicating a connection relationship among a video transmission terminal that transmits a video flow, a transmission device connected to the video transmission terminal, a video reception terminal that receives the video flow, and a transmission device connected to the video reception terminal;
when a transmission device connected to an optical fiber in which a change in the optical signal has occurred is specified, referring to the video flow database and specifies a video reception terminal connected to the transmission device specified, and a video transmission terminal; and
displaying an image indicating identification information regarding a video flow flowing from the video transmission terminal to the video reception terminal that are specified.

12. The visualization method according to claim 9, further comprising:
detecting that the stimulus is applied in a case where a user applies a bending stress to the optical fiber on the basis of the image captured by the image capturing unit.

13. The visualization method according to claim 7, wherein the change occurring in the optical signal is a change in at least one of a light reception level, a variance of a constellation, or a bit error rate.

14. The non-transitory computer-readable storage medium according to claim 8, wherein the operations further comprise:
detecting that a stimulus is applied to the optical fiber on a basis of an image captured by an image capturing unit that captures an image of the optical fiber; and
displaying the identification information in a case where it is detected that a stimulus is applied to the optical fiber.

15. The non-transitory computer-readable storage medium according to claim 14, wherein the operations further comprise:
superimposing and displays the identification information on either one of a real image in which a physical stimulus is applied to the optical fiber or an image, captured by the image capturing unit, of a state in which the physical stimulus is applied to the optical fiber.

16. The non-transitory computer-readable storage medium according to claim 14, wherein the operations further comprise:
storing, in a video flow database, data indicating a connection relationship among a video transmission terminal that transmits a video flow, a transmission device connected to the video transmission terminal, a video reception terminal that receives the video flow, and a transmission device connected to the video reception terminal;
when a transmission device connected to an optical fiber in which a change in the optical signal has occurred is specified, referring to the video flow database and specifies a video reception terminal connected to the transmission device specified, and a video transmission terminal; and
displaying an image indicating identification information regarding a video flow flowing from the video transmission terminal to the video reception terminal that are specified.

17. The non-transitory computer-readable storage medium according to claim 14, wherein the operations further comprise:
detecting that the stimulus is applied in a case where a user applies a bending stress to the optical fiber on the basis of the image captured by the image capturing unit.

18. The non-transitory computer-readable storage medium according to claim 8, wherein the change occurring in the optical signal is a change in at least one of a light reception level, a variance of a constellation, or a bit error rate.
